(19) United States
(12) Patent Application Publication
(10) Pub. No.: US 2006/0009581 A1
(43) Pub. Date: Jan. 12, 2006

(54) Self-bonding insulated wire

(76) Inventors: Fusamori Araki, Kyoto (JP); Kazushige Tamura, Shiga (JP); Seiichi Nagamine, Shiga (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/527,780

(22) PCT Filed: Sep. 17, 2003
(86) PCT No.: PCT/JP03/11863

§ 371 Date: Mar. 15, 2005

(30) Foreign Application Priority Data
Sep. 30, 2002 (JP) 2002-233689

(51) Int. Cl. C08F 8/30

(52) U.S. Cl. 525/178

(57) ABSTRACT

Provided is a self-bonding insulated wire in which a bonding layer is formed on an insulated wire, wherein the bonding layer is formed by applying a bonding varnish obtained by dissolving a crystalline copolyamide resin having a melting point within a temperature range of 105 to 150° C. and an alcohol-soluble copolyamide resin having a flexural modulus of 1500 MPa or more in a mixed organic solvent containing an alcoholic organic solvent. Because the self-bonding insulated wire of the present invention has a reduced amount of remaining phenolic solvent in its bonding layer, the wire is characterized in that the odor of the phenolic solvent released from the wire and the odor of the phenolic solvent which generates during the fabrication of a deflection yoke coil from the self-bonding insulated wire by means of a coil winder are reduced and that the initial twist of the deflection yoke coil after coiling, heat bonding and press molding is small.

### TECHNICAL FIELD

The present invention relates to a self-bonding insulated wire suitable for the production of deflection yoke coils for use in television receivers, computer displays and the like.

### BACKGROUND ART

A self-bonding insulated wire has a bonding layer as its outermost layer. The self-bonding insulated wire is coiled around a mold and the outermost bonding layer is molten or swollen by electric heating or solvent treatment, whereby the adjacent wires can be bonded and solidified. Therefore, self-supporting coils can be prepared easily therefrom. Like this, since-the self-bonding insulated wire can improve the productivity of electric apparatus coils and can reduce their production cost, it has been popularly used in coils of household electric appliances, office automation machines, electric fixtures and accessories, deflection yokes for CRT display, and the like.

In particular, products in which deflection yoke coils, which are recently in wide use, are employed have been advanced in miniaturization, improvement in heat resistance, high voltage application and high frequency application. Therefore, the deflection yoke coil is required to be small in dimensional change at ordinary and high temperatures and in initial twist (which is a difference between the size of coil and the size of a mold for coiling and is evaluated by measuring the neck diameter of coil and the amount of distortion) observed when forming a coil by winding a wire around the coiling mold and subjecting the wound wire to melt-bonding. To meet these requirements, self-bonding insulated wires are required to be excellent in heat distortion resistance and bonding strength characteristic at both ordinary temperature and high temperature.

Heretofore, epoxy resin (phenoxy resin) has been used as a bonding resin for forming the bonding layer of the self-bonding insulated wire. However, copolyamide resin of well-balanced heat resistance and bonding property has been employed recently.

Such self-bonding insulated wires are produced by a procedure in which an insulating varnish e.g., polyester imide varnish, polyester imide urethane varnish and polyurethane varnish, is applied to a conductor and baked twice or more to form an insulated wire onto which is then applied a bonding varnish prepared by dissolving a resin component containing a copolyamide resin as its main ingredient in a phenolic organic solvent, such as cresol, phenol and xylenol, by means of a die, and the coated wire is introduced to a baking oven to evaporate the solvent, thereby forming a bonding layer. This method has advantages that any resin can be used for a bonding varnish as long as it is soluble in a solvent and that a viscosity reduction required during the application onto an insulated wire is possible.

However, there is a problem in which when a bonding varnish is applied onto an insulated wire and baked, the phenolic organic solvent necessarily vaporizes to the work environment to pollute the environment and the phenolic organic solvent will remain in the self-bonding insulated wire in a very small amount.

As described above, a self-bonding insulated wire is coiled around a mold and then electrically heated, thereby being fabricated into a coil. However, there is a problem in which a phenolic organic solvent, which remains in a bonding layer of a self-bonding insulated wire in a very small amount, will vaporize during the electric heating in the coiling operation.

Since phenolic organic solvents are harmful from the viewpoints of odor and environment as described above, it is necessary to decrease the residual phenolic organic solvents in the bonding layer as much as possible.

In the field of self-bonding insulated wires using copolyamide resin as a resin to constitute a bonding layer, JP-A-10-154420 discloses a technology in which an initial twist or dimensional change caused when a wire is coiled around a coiling mold and then melt-bonded into a coil is minimized or in which a bonding property is improved through addition of 2-10 parts by weight of a high-melting nylon having a melting point of 200-300° C. to 100 parts by weight of a copolyamide resin. However, use of a solvent containing an alcoholic solvent for the purpose of reduction in odor may result in an insufficient solubility of high-melting nylon.

In this respect, Japanese Unexamined Patent Publication No. 8-17251 (paragraph number 0007) and Japanese Unexamined Patent Publication No. 8-287727 (paragraph number 0022) propose to eliminate such problems by use of benzyl alcohol which is effective with respect to odor and environment as an organic solvent of a bonding varnish. However, benzyl alcohol is insufficient in solubility of resins and has a problem in which it can dissolve only a specific copolyamide soluble in alcohol as well as a problem in which it remains easily in a bonding coat film.

JP-A-11-53952 (paragraph number 0005) discloses that low offensive odor, self-bonding magnetic wires are realized by using as an organic solvent a mixed organic solvent comprising an alcoholic solvent such as amyl alcohol, hexyl alcohol, heptyl alcohol or octyl alcohol and an aromatic organic solvent of cresol-xylene main component and adding a phenol resin. However, the effect of reducing odor is not sufficient enough because odor generates from the phenol resin during the DY coil winding. In addition, the dimensional change after the DY coil winding is also mentioned, but it unsatisfactory. Moreover, there is no disclosure about an alcohol-soluble copolyamide resin having a specific flexural modulus.

Examples shown in JP-A-8-249936 disclose an alcohol coil resulting from baking a bonding varnish obtained by dissolving an alcohol-soluble polyamide resin having a melting point higher than 155° C. and an alcohol-insoluble polyamide resin having a melting point not higher than 155° C. on a conductor through an insulating layer and a self-bonding magnet wire which can be coiled by hot air. However, the document contains neither a concrete description about a case where an alcoholic solvent is used nor a reference to a relation between the flexural modulus of a polyamide resin used and an initial twist of a coil.

No proposal to solve both problems with coils, odor and initial twist, has been made.

### DISCLOSURE OF THE INVENTION

The purpose of the present invention is to solve the problems with the above-mentioned conventional technologies in the field of self-bonding insulated wire and to provide a self-bonding insulated wire which can reduce the amount of the phenolic organic solvent remaining within the bonding layer of the self-bonding insulated wire, which has no odor environmental problem because gas of the phenolic organic solvent is formed in a small amount when an electric apparatus coil is formed using the self-bonding insulated wire, and a coil of which has a small initial twist because the bonding layer has a high flexural modulus.

The present invention relates to a self-bonding insulated wire in which an insulated wire has thereon a bonding layer formed through application and baking of a bonding varnish, wherein the bonding varnish comprises:
(A) a crystalline copolyamide resin having a melting point within a temperature range of 105-150° C.,
(B) an alcohol-soluble copolyamide resin with a flexural modulus of not less than 1500 MPa, and
(C) an organic solvent containing an alcoholic organic solvent.

Bonding Varnish

(A) Crystalline Copolyamide Resin

The crystalline copolyamide resin in the present invention is preferably, but not particularly limited to, that having a melting point within the temperature range of 105 to 150° C., more preferably within the temperature range of 120 to 150° C. When the melting point of the crystalline copolyamide resin is 105° C. or lower, the heat resistance of the self-bonding insulated wire tends to be insufficient. On the other hand, when the melting point is over 150° C., the bonding property obtained during the formation of a deflection yoke coil becomes poor and problems such as loosening of wire may arise.

In addition, examples of such crystalline copolyamide include copolymers such as nylon 6, nylon 66, nylon 610, nylon 612, nylon 11, nylon 12 and isophoronediamine-adipate; commercially available products thereof include X7079, 431, 451 and 471 available from Daicel-Degussa Ltd. and M1186, M2269, MX2441, MX2447 and MX2454 available from Atofina Chemicals., Inc.

(B) Alcohol-Soluble Copolyamide Resin

The alcohol-soluble copolyamide resin is an alcohol-soluble copolyamide resin with a flexural modulus of not less than 1500 MPa. The present inventors focused their attentions on a relation between the flexural modulus of the alcohol-soluble copolyamide resin to be added to the crystalline copolyamide resin and the initial twist of a formed coil and examined alcohol-soluble copolyamide resins varying in flexural modulus. As a result, they found that those having a flexural modulus of not less than 1500 MPa are effective.

“To be alcohol-soluble” means to dissolve in an amount of 20 g or more in 100 g of an alcoholic solvent (methanol).

The ingredient (B) preferably contains at least two selected from a reaction product of isophoronediamine and sebacic acid, a reaction product of isophoronediamine and azelaic acid, a reaction product of isophoronediamine and adipic acid, a nylon 6 monomer unit, a nylon 66 monomer unit, a nylon 610 monomer unit, a nylon 11 monomer unit and a nylon 12 monomer unit. Examples of commercially available products thereof include X1010 and X4685 from Daicel-Degussa Ltd. and MX2386 from Atofina Chemicals., Inc. The flexural modulus of the ingredient (B) is preferably 1700 MPa or more.

The amount of the ingredient (B) added is preferably 5-20 parts by weight for 100 parts by weight of the ingredient (A). If 5 parts by weight or less, the bonding layer will have a flexural modulus of 600 MPa or less and when a coil is wound around a coiling mold and then melt-bonded to be formed, a deflection yoke coil may cause an initial twist. If 20 parts by weight or more, the bonding force between wires and the heat deformability tend to reduce.

(C) Organic Solvent Containing Alcoholic Organic Solvent

In the present invention, an alcoholic organic solvent is essential. The use of an alcoholic organic solvent makes it possible to reduce odor. Examples of the alcoholic organic solvent include pentanol, hexanol, cyclohexanol, heptanol, 2-ethylhexanol, octanol and amyl alcohol. Among these, 2-ethylhexanol is preferable because of its excellent resin solubility.

When an organic solvent other than the alcoholic organic solvent is used together, it is appropriate that the content of the alcoholic organic solvent be 5-30% by weight, more preferably 10-25% by weight of the amount of the whole solvent in view of solubility, varnish stability and the like. If the content of the alcoholic organic solvent is less than 10% by weight, the effect of reducing odor may not be obtained sufficiently. It may be over 30% by weight, but if so, the solubility and the varnish stability tend to reduce.

For the purpose of improvement in solubility and varnish stability, the ingredient (C) may contain an organic solvent other than the alcoholic organic solvent to an extent such that the odor is worsened. For example, phenolic organic solvents such as cresol (cresylic acid), phenol and xylenol and N-methylpyrrolidone may also be used. In addition, poor solvents such as solvent naphtha, various aromatic hydrocarbons, xylene and toluene may be used together with the afore-mentioned good solvents. The solvents may be used alone or in combination of two or more of them.

Because the use of an alcoholic organic solvent can reduce the content of a phenolic organic solvent or the like, the content of the phenolic organic solvent in the ingredient (C) is preferably 40% by weight or less of the amount of the whole solvent. If over 40% by weight, the odor may be worsened because the amount of the phenolic organic solvent remaining in the self-bonding insulated wire fabricated using the bonding varnish will increase. On the other hand, if less than 20% by weight, the solubility of a varnish tends to reduce.

An aromatic hydrocarbon may be contained as the ingredient (C). In view of odor and solubility, the amount of the same used is preferably 30-60% by weight, more preferably 35-55% by weight of the amount of the whole solvent. If the content of the aromatic hydrocarbon in the organic solvent is less than 35% by weight, the odor may be worsened. If over 60% by weight, a solubility problem and a varnish stability tend to be worsened.

(D) Other Ingredients

In the present invention, various additives may be incorporated into a bonding varnish. As such additives, any antioxidant well known may be employed without any limitations in order to prevent the bonding force between wires of a deflection coil from being reduced at the time of its practical use.

For the purpose of enabling a self-bonding insulated wire to be used as a self-lubricating insulated wires by imparting a good lubricity to the self-bonding insulated wire, a suitable lubricant may be added to the bonding vanish so long as the effects of the present invention are not impaired.

Self-Bonding Insulated Wire

The self-bonding insulated wire of the present invention is a product formed by applying a bonding varnish which contains the ingredients (A)-(C) and, as required, other ingredients such as an antioxidant and a lubricant onto an insulated wire and baking.

The resin content in the bonding varnish is preferably 10-25% by weight depending upon the size of the insulated wire used. If the resin content is less than 10% by weight, not only the application-baking operation must be repeated any number of times to form a bonding layer having a desired thickness, leading to reduction in productivity, but also the amount of residual solvent in the bonding layer may increase. If the resin content is more than 25% by weight, the viscosity of the bonding varnish increases, so the application-baking workability is greatly deteriorated and also there may be a case where polyamide resins are not homogeneously dissolved in the solvent used for the bonding varnish.

The insulated wires used in the self-bonding insulated wire of the present invention comprise a conductor, such as copper, copper alloy, aluminum or aluminum alloy, having thereon an insulating layer formed by coating the conductor with polyesterimide, polyurethane, polyester, polyesterimide urethane, polyamideimide, polyamideimide urethane, polyimide, polyesteramide, polyesteramideimide or the like.

The method for applying the bonding varnish to insulated wires is not limited particularly if it is an application method conventionally known. For example, a die squeezing method and a felt squeezing method may be employed.

The thickness of the bonding layer of the self-bonding insulated wire of the present invention varies depending on the kind and size of the self-bonding insulated wire, but is from 5 to 20 μm, and is about 10 μm. If the thickness is less than 5 μm, a proper bonding force is not obtained when producing deflection coils. If the thickness is more than 20 μm, the cost increases.

A suitable lubricant may be applied on the bonding layer of the self-bonding insulated wire as long as the effects of the present invention are not impaired, for the purpose of enabling to use as a self-lubricating insulated wires by imparting a good lubricity to the self-bonding insulated wires of the present invention.

### BRIEF DESCRIPTION OF THE DRAWINGS

FIG. 1 is an explanatory view showing a deflection yoke coil made from a self-bonding insulated wire and a self-bonding litz wire;

FIG. 2 is an explanatory view showing the sites where the dimensions of a deflection yoke coil prepared are measured; and

FIG. 3 is an explanatory view showing a method for measuring the bonding force of a deflection yoke coil prepared.

### BEST MODE FOR CARRYING OUT THE INVENTION

The self-bonding insulated wire of the present invention is explained in more detail based on Examples and Comparative Examples. The invention, however, is not limited to these examples. Methods for evaluations employed in Examples and Comparative Examples are summarized below.

(Resin Content)

After heating 1.5 g of a bonding varnish at 170° C. for 2 hours, the non-volatile portion was weighed and the resin content (%) was calculated according to a formula, (weight of non-volatile portion)/(weight of bonding varnish).

(Resin Solubility)

The resin solubility was evaluated based on the condition of a varnish when a bonding resin is dissolved in a solvent and then cooled to room temperature. A case where no solidification or no gelation occurred, it is indicated by ◯ and in the case where solidification or gelation occurred is indicated by ×.

(Storage Stability)

The storage stability was evaluated based on the condition of a varnish obtained by dissolving a bonding resin in a solvent which had been left to stand at room temperature for 168 hours. A case where there was almost no change in flowability is indicated by ◯, whereas a case where increase in viscosity, solidification or gelation occurred is indicated by ×.

(Flexural Modulus)

The flexural modulus of a copolyamide resin was measured using an ASTM specimen prepared from a pellet thereof. The flexural modulus of a bonding layer was measured using an ASTM specimen prepared after dissolving about 2 kg of a self-bonding insulated wire in cresol and heat treating it.

(Odor)

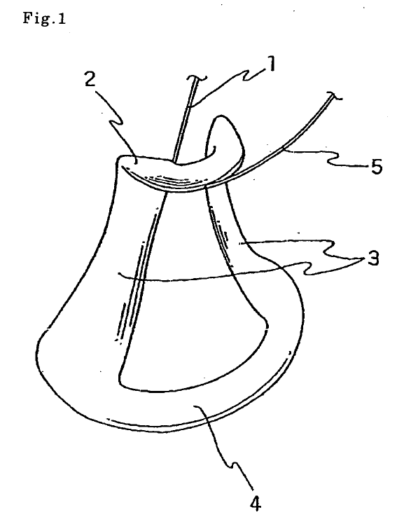

A deflection yoke coil shown in FIG. 1 was produced by coiling, electric heating and press molding while using a coil winder (mold dimensions: neck diameter=40.4 mm, distortion=0.0 mm) and setting molding condition to 58 turns*2 wires, electric heating time=1.5 seconds, applied electric current=60 A, cooling press time=25 seconds and mold temperature=40° C. It is noted that in FIG. 1, numerals 1, 2, 3, 4 and 5 indicate the beginning of a wound wire, an upper flange, a wound section of the wire, a bottom flange and the end of the wound wire, respectively. A smell was taken at a deflection yoke coil obtained. A case where no odor of a phenolic organic solvent was recognized is indicated by ◯, whereas a case where odor was recognized even in small degrees is indicated by ×.

(Amount of Gas)

A deflection yoke coil obtained was heated at 95° C. for 10 minutes. The gas generated was captured in a primary trap tube and subjected to purge & trap gas chromatography. As measuring apparatus, an out gas sampler “HDD-500”, a Curie point purge & trap sampler “JHS-100A” and a Curie point pyrolyzer “JHP-3”, manufactured by Japan Analytical Industry Co., Ltd., and a gas chromatography “GC-14B” manufactured by Shimadzu Corp. were used. The amount of the gas generated is indicated by a ratio of the amount of the gas generated to the weight of the bonding layer in the deflection yoke coil. The alcoholic organic solvent remains partly in the bonding coat film of the self-bonding insulated wire. It can be confirmed by mass analysis after the purge & trap gas chromatograph.

(Coil Size)

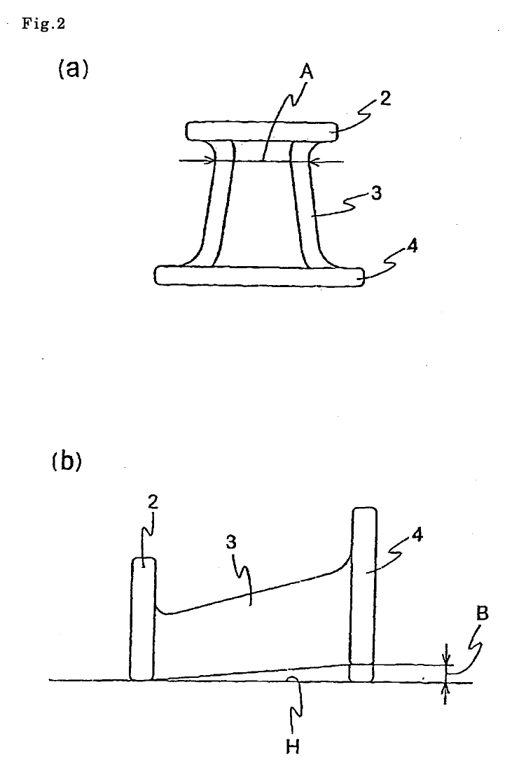

In a deflection coil obtained, with respect to locations for measurement of size of the coil shown in FIG. 2, the neck diameter was measured with a caliper and the amount of distortion was measured with a clearance gage.

(Bonding Force between Wires)

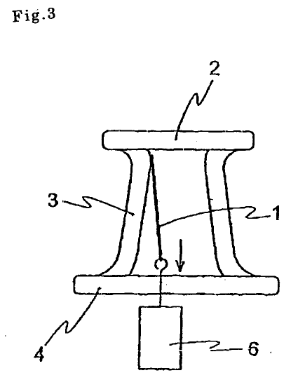

A deflection yoke coil obtained was left to stand at room temperature for 24 hours. The bonding force of one turn in the inside part of the deflection yoke coil was measured with a tension gauge as shown in FIG. 3.

(Amount of Change in Neck Diameter after Heat Resistance Test (Heat Distortion Resistance))

An obtained deflection coil was heated at an oven kept at 120° C. or 130° C. for 2 hours, allowed to stand to cool to room temperature and the diameter of the neck of the coil was measured. The amount of change in neck diameter between before and after the heating is shown.

### EXAMPLE 1

A bonding varnish was obtained by dissolving a resin component containing 10 parts by weight of MX2386 with a flexural modulus of 2200 MPa available from Atofina Chemicals., Inc. for 100 parts by weight of X7079 (melting point=130° C.) which is a crystalline copolyamide resin of Daicel-Degussa Ltd., in a mixed organic solvent with a weight ratio of cresylic acid: SWASOL 1000, which is a C9 naphtha, available from Maruzen Petrochemical Co., Ltd.: 2-ethylhexanol=40:40:20 so that the resin content might be 15% by weight. The obtained bonding varnish had a viscosity of 20 dPa·s at 30° C. A self-bonding insulated wire having a bonding coating film with a thickness of 10 μm was obtained by three time repetition of application of the bonding varnish onto a polyesterimide-insulated wire having an outer diameter of conductor=0.15 mm and an outer diameter of insulated wire=0.19 mm (by a die squeezing method) and baking (oven length=3.0 m, oven temperature=300° C., line speed=60 m/min). Furthermore, ten self-bonding insulated wires were intertwisted together to form a self-bonding Litz wire. The results obtained above are summarized in Table 1.

### EXAMPLE 2

Example 1 was repeated except using a mixed solvent with a weight ratio of cresylic acid: SWASOL 1000:2-ethylhexanol=40:50:10. The results are shown in Table 1.

### EXAMPLE 3

Example 1 was repeated except using a mixed solvent with a weight ratio of cresylic acid: SWASOL 1000:2-ethylhexanol=30:50:20. The results are shown in Table 1.

### EXAMPLE 4

Example 1 was repeated except using a mixed solvent with a weight ratio of cresylic acid: SWASOL 1000:2-ethylhexanol=40:35:25. The results are shown in Table 1.

### EXAMPLE 5

Example 1 was repeated except using a mixed solvent with a weight ratio of cresylic acid: SWASOL 1000:2-ethylhexanol=35:55:10. The results are shown in Table 1.

### EXAMPLE 6

Example 1 was repeated except changing the amount of MX2386 added to 15 parts by weight for 100 parts by weight of X7079. The results are shown in Table 1.

### EXAMPLE 7

Example 1 was repeated except changing the amount of MX2386 added to 20 parts by weight for 100 parts by weight of X7079. The results are shown in Table 1.

### EXAMPLE 8

Example 1 was repeated except using, as an alcohol-soluble copolyamide resin, X4685 with a flexural modulus of 1900 MPa available from Daicel-Degussa Ltd. The results are shown in Table 1.

### EXAMPLE 9

Example 1 was repeated except using, as an alcohol-soluble copolyamide resin, X1010 with a flexural modulus of 1700 MPa available from Daicel-Degussa Ltd. The results are shown in Table 1.

### COMPARATIVE EXAMPLE 1

Example 1 was repeated except changing the organic solvent to 100% by weight of benzyl alcohol. The results are shown in Table 2.

### COMPARATIVE EXAMPLE 2

The procedure of Example 1 was repeated except changing the organic solvent to 100% by weight of cresylic acid. The results are shown in Table 2.

### COMPARATIVE EXAMPLE 3

The procedure of Example 1 was repeated except using a mixed organic solvent with a weight ratio of cresylic acid: SWASOL 1000 of 70:30. The results are shown in Table 2.

### COMPARATIVE EXAMPLE 4

The procedure of Example 1 was repeated except using a mixed organic solvent with a weight ratio of cresylic acid: SWASOL 1000=60:40. The results are shown in Table 2.

### COMPARATIVE EXAMPLE 5

The procedure of Example 1 was repeated except using a mixed organic solvent with a weight ratio of benzyl alcohol:cresylic acid:SWASOL 1000=60:15:25. The results are shown in Table 2.

### COMPARATIVE EXAMPLE 6

A bonding varnish was obtained by dissolving 100 parts by weight of X7079 in a mixed organic solvent with a weight ratio of cresylic acid: SWASOL 1000=70:30 so that the resin content might be 15% by weight. The procedure of Example 1 was repeated except this modification. The results are shown in Table 2.

### COMPARATIVE EXAMPLE 7

The procedure of Example 1 was repeated except using, as an alcohol-soluble copolyamide resin, Z2057 with a flexural modulus of 1200 MPa available from Daicel-Degussa Ltd. The results are shown in Table 2.

### COMPARATIVE EXAMPLE 8

The procedure of Example 1 was repeated except using, as an alcohol-soluble copolyamide resin, CM4001 with a flexural modulus of 1400 MPa available from Toray Industries, Inc. The results are shown in Table 2.

### COMPARATIVE EXAMPLE 9

The procedure of Example 1 was repeated except changing the amount of a nylon 66 with a melting point of 260° C. added as a high-melting nylon resin to 5 parts by weight for 100 parts by weight of X7079. The results are shown in Table 2.

### COMPARATIVE EXAMPLE 10

A bonding varnish was obtained by dissolving a resin component containing a nylon 66 with a melting point of 260° C. as a high-melting nylon resin at a proportion of 5 parts by weight for 100 parts by weight of X7079 in a mixed organic solvent with a weight ratio of cresylic acid: SWASOL 1000=70:30 so that the resin content might be 15% by weight. The procedure of Example 1 was repeated except this modification. The results are shown in Table 2.

TABLE 1

| | | | Example | Example | Example | Example | Example | Example | Example | Example | Example |
|---|---|---|---|---|---|---|---|---|---|---|---|
| | | | 1 | 2 | 3 | 4 | 5 | 6 | 7 | 8 | 9 |
| Bonding varnish | Amount of alcohol- | | 10 | 10 | 10 | 10 | 10 | 15 | 20 | 10 | 10 |
| | soluble copolyamide | | | | | | | | | | |
| | resin (parts) | | | | | | | | | | |
| | Flexural modulus | | 2200 | 2200 | 2200 | 2200 | 2200 | 2200 | 2200 | 1900 | 1700 |
| | of alcohol-soluble | | | | | | | | | | |
| | copolyamide | | | | | | | | | | |
| | resin (MPa) | | | | | | | | | | |
| | Composition | 2-Ethyl- | 20 | 10 | 20 | 25 | 10 | 20 | 20 | 20 | 20 |
| | of solvent | hexanol | | | | | | | | | |
| | (% by | Cresylic | 40 | 40 | 30 | 40 | 35 | 40 | 40 | 40 | 40 |
| | weight) | acid | | | | | | | | | |
| | | C9 | 40 | 50 | 50 | 35 | 55 | 40 | 40 | 40 | 40 |
| | | Naphtha | | | | | | | | | |

| | Content of | 15 | 15 | 15 | 15 | 15 | 15 | 15 | 15 | 15 |
|---|---|---|---|---|---|---|---|---|---|---|
| | resin (wt %) | | | | | | | | | |
| | Resin | ◯ | ◯ | ◯ | ◯ | ◯ | ◯ | ◯ | ◯ | ◯ |
| | solubility | | | | | | | | | |
| | Storage | ◯ | ◯ | ◯ | ◯ | ◯ | ◯ | ◯ | ◯ | ◯ |
| | stability | | | | | | | | | |
| Flexural modulus of bonding | | 700 | 700 | 700 | 700 | 700 | 800 | 900 | 700 | 680 |
| layer (MPa) | | | | | | | | | | |
| Odor | | ◯ | ◯ | ◯ | ◯ | ◯ | ◯ | ◯ | ◯ | ◯ |
| Amount of gas | Alcoholic | 70 | 40 | 60 | 95 | 20 | 70 | 70 | 70 | 70 |
| from coil (ppm) | solvent | | | | | | | | | |
| | Phenolic | 280 | 300 | 200 | 260 | 240 | 280 | 280 | 280 | 280 |
| | solvent | | | | | | | | | |
| | Benzyl | — | — | — | — | — | — | — | — | — |
| | alcohol | | | | | | | | | |
| Coil size (mm) | Neck | 40.4 | 40.4 | 40.4 | 40.4 | 40.4 | 40.4 | 40.4 | 40.4 | 40.4 |
| | diameter | | | | | | | | | |
| | Amount of | 0.3 | 0.3 | 0.3 | 0.3 | 0.3 | 0.2 | 0.2 | 0.3 | 0.3 |
| | distortion | | | | | | | | | |
| Change in neck | 120° C. | 0.1 | 0.1 | 0.1 | 0.1 | 0.1 | 0.2 | 0.4 | 0.1 | 0.1 |
| diameter after | 130° C. | 0.3 | 0.3 | 0.3 | 0.3 | 0.3 | 0.5 | 0.8 | 0.3 | 0.3 |
| heat resistance | | | | | | | | | | |
| (mm) | | | | | | | | | | |

| | | | | | | | | | |
|---|---|---|---|---|---|---|---|---|---|
| Bonding force between | 7.3 | 7.4 | 7.2 | 7.3 | 7.1 | 7.0 | 6.8 | 7.2 | 7.1 |
| wires (N) | | | | | | | | | |

TABLE 2

| | | | Com- | Com- | Com- | Com- | Com- | Com- | Com- | Com- | Com- | Com- |
|---|---|---|---|---|---|---|---|---|---|---|---|---|
| | | | par- | par- | par- | par- | par- | par- | par- | par- | par- | par- |
| | | | ative | ative | ative | ative | ative | ative | ative | ative | ative | ative |
| | | | Ex- | Ex- | Ex- | Ex- | Ex- | Ex- | Ex- | Ex- | Ex- | Ex- |
| | | | ample | ample | ample | ample | ample | ample | ample | ample | ample | ample |
| | | | 1 | 2 | 3 | 4 | 5 | 6 | 7 | 8 | 9 | 10 |
| Bonding varnish | Amount of | | 10 | 10 | 10 | 10 | 10 | 0 | 10 | 20 | — | — |
| | alcohol-soluble | | | | | | | | | | | |
| | copolyamide | | | | | | | | | | | |
| | resin (parts) | | | | | | | | | | | |
| | Flexural modulus | | 2200 | 2200 | 2200 | 2200 | 2200 | — | 1200 | 1400 | — | — |
| | of alcohol- | | | | | | | | | | | |
| | soluble copolyam- | | | | | | | | | | | |
| | ide resin (MPa) | | | | | | | | | | | |
| | Amount of nylon | | — | — | — | — | — | — | — | — | 5 | 5 |
| | 66 added (parts) | | | | | | | | | | | |
| | Composition | 2-Ethylhexanol | — | — | — | — | — | — | 20 | 20 | 20 | — |
| | of solvent | | | | | | | | | | | |
| | (% by weight) | | | | | | | | | | | |
| | | Cresylic acid | — | 100 | 70 | 60 | 15 | 70 | 40 | 40 | 40 | 70 |
| | | C9 Naphtha | — | — | 30 | 40 | 25 | 30 | 40 | 40 | 40 | 30 |
| | | Benzyl alcohol | 100 | — | — | — | 60 | — | — | — | — | — |

| | | | | | | | | | | |
|---|---|---|---|---|---|---|---|---|---|---|
| Resin content (wt %) | 10 | 15 | 15 | 15 | 15 | 15 | 15 | 15 | 15 | 15 |
| Resin solubility | X | ◯ | ◯ | ◯ | ◯ | ◯ | ◯ | ◯ | X | ◯ |
| Storage stability | X | ◯ | ◯ | ◯ | ◯ | ◯ | ◯ | ◯ | X | ◯ |

| Flexural modulus of | | 700 | 700 | 700 | 700 | 700 | 500 | 510 | 550 | — | 950 |
|---|---|---|---|---|---|---|---|---|---|---|---|
| bonding layer (MPa) | | | | | | | | | | | |
| Odor | | X | X | X | X | X | X | ◯ | ◯ | — | X |
| Amount of gas from | Alcoholic solvent | — | — | — | — | — | — | 70 | 70 | — | — |
| coil (ppm) | | | | | | | | | | | |
| | Phenolic solvent | — | 1000 | 600 | 500 | 250 | 600 | 280 | 280 | — | 600 |
| | Benzyl alcohol | 1100 | — | — | — | 800 | — | — | — | — | — |
| Coil size (mm) | Neck diameter | 40.5 | 40.4 | 40.4 | 40.4 | 40.5 | 40.6 | 40.6 | 40.5 | — | 40.4 |
| | Amount of | 0.3 | 0.3 | 0.3 | 0.3 | 0.3 | 0.7 | 0.7 | 0.6 | — | 0.2 |
| | distortion | | | | | | | | | | |
| Change in neck | 120° C. | 0.2 | 0.1 | 0.1 | 0.1 | 0.2 | 0.3 | 0.3 | 0.3 | — | 0.1 |
| diameter after | 130° C. | 0.4 | 0.3 | 0.3 | 0.3 | 0.4 | 1.2 | 1.0 | 1.0 | — | 0.4 |
| heat resistance | | | | | | | | | | | |
| (mm) | | | | | | | | | | | |

| | | | | | | | | | | |
|---|---|---|---|---|---|---|---|---|---|---|
| Bonding force between | 7.0 | 7.4 | 7.3 | 7.3 | 7.1 | 7.3 | 6.3 | 6.5 | — | 6.8 |
| wires (N) | | | | | | | | | | |

*In Comparison Example 9, resins did not dissolve.

(Note 1)
Target level
Amount of gas from coil: 500 ppm or less
Amount of distortion of coil: 0.3 mm or less (When more than 0.3 mm, the convergence characteristic of a formed coil will change.)
Bonding force of coil: 6.5 N or more (When less than 6.5 N, wires will become liable to being loosened.)
   (Note 2)
Dimensions of coiling mold
Neck diameter: 40.4 mm
Distortion: 0 mm

As is obvious from Table 2, Comparative Example 1, in which benzyl alcohol was employed as a solvent, is not available because there are problems in resin solubility, and storage stability.

In Comparative Examples 2 to 6, a large amount of gas generated from a coil and there are odor problems. In Comparative Examples 2 to 5 in which an alcohol-soluble copolyamide resin with a flexural modulus of 2200 MPa was added, the amount of distortion of a coil after its fabrication is small because of a high flexural modulus of a bonding layer. In contrast to this, in Comparative Example 6 using only for a crystalline copolyamide resin, the amount of distortion of a coil after its fabrication is large and the amount of thermal distortion is also large because of a low flexural modulus of a bonding layer.

In Comparative Example 7, which relates to addition of an alcohol-soluble copolyamide resin with a flexural modulus of 1200 MPa, the amount of distortion of a coil after its fabrication is under the target level. Similar results are found in Comparative Example 8 relating to addition of an alcohol-soluble copolyamide resin with a flexural modulus of 1400 MPa.

Comparative Examples 9 and 10 relate to addition of nylon 66, which is a high-melting nylon resin. Comparative Example 10, which relates to a method disclosed in Japanese Unexamined Patent Publication No. 10-154420, resulted in a satisfactory amount of distortion of a coil because of a high flexural modulus of a bonding layer. However, there are odor problems. In contrast to this, Comparative Example 9, which employed a solvent composition of the present invention, is not available because there is a problem in the solubility of nylon 66.

In contrast to these Comparative Examples, the bonding varnishes of Examples 1 to 9 are good in resin solubility and storage stability. The self-bonding insulated wires obtained by applying these bonding varnishes onto insulated wires followed by baking do not cause odor environmental problems because when these wires are fabricated into deflection yoke coils, the amounts of phenolic organic solvent gas released from the coils are small. Furthermore, the coils showed small initial twists and also showed good resistance to heat deformation even at a high temperature (120° C.) because of high flexural moduli of the bonding layers.

### INDUSTRIAL APPLICABILITY

The self-bonding insulated wire of the present invention can reduce the amount of the phenolic organic solvent remaining within its bonding layer and causes no odor environmental problems because when an electric apparatus coil is fabricated from the self-bonding insulated wire, gas of the phenolic organic solvent is formed in a small amount. In addition, a coil thereof has a small initial twist because the bonding layer thereof has a high flexural modulus. Therefore, the self-bonding insulated wire of the present invention is extremely useful in industry.

### EXPLANATION OF REFERENCE NUMERALS

1 The beginning of wound wire
2 Top flange
3 Wound section of wire
4 Bottom flange
5 The end of wound wire
6 Tension gauge
A Neck diameter
B Amount of distortion
H Horizontal plane

1. A self-bonding insulated wire in which an insulated wire has thereon a bonding layer formed through application and baking of a bonding varnish, wherein the bonding varnish comprises:
(A) a crystalline copolyamide resin having a melting point within a temperature range of 105-150° C.,
(B) an alcohol-soluble copolyamide resin with a flexural modulus of not less than 1500 MPa, and
(C) an organic solvent containing an alcoholic organic solvent.

2. The self-bonding insulated wire according to claim 1, wherein the content of the alcoholic organic solvent in the ingredient (C) is 5-30% by weight of the amount of the whole solvent.

3. The self-bonding insulated wire according to claim 2, wherein the alcoholic organic solvent in the ingredient (C) is 2-ethylhexanol.

4. The self-bonding insulated wire according to claim 1, wherein the ingredient (C) is a phenolic organic solvent and/or an aromatic hydrocarbon.

5. The self-bonding insulated wire according to claim 4, wherein the content of the phenolic organic solvent in the ingredient (C) is not more than 40% by weight based on the amount of the whole solvent.

6. The self-bonding insulated wire according to claim 1, wherein the content of the aromatic hydrocarbon in the ingredient (C) is 30-60% by weight based on the amount of the whole solvent.

7. The self-bonding insulated wire according to claim 1, wherein the ingredient (B) contains at least two selected from a reaction product of isophoronediamine and sebacic acid, a reaction product of isophoronediamine and azelaic acid, a reaction product of isophoronediamine and adipic acid, a nylon 6 monomer unit, a nylon 66 monomer unit, a nylon 610 monomer unit, a nylon 11 monomer unit and a nylon 12 monomer unit.

8. The self-bonding insulated wire according to claim 1, wherein the amount of the ingredient (B) added is 5-20 parts by weight for 100 parts by weight of the ingredient (A).

9. A self-bonding insulated wire in which an insulated wire has thereon a bonding layer, wherein the bonding layer has a flexural modulus of 600-1000 MPa and the amount of gas of the alcoholic organic solvent released from the bonding layer is within the range of 0.1-100 ppm.

10. A self-bonding insulated wire in which an insulated wire has thereon a bonding layer, wherein a deflection yoke coil obtained by coiling, electric heating and press molding while using a coil winder under molding conditions set to 58 turns*2 wires, electric heating time of 1.5 seconds, applied electric current of 60 A, cooling press time of 25 seconds and mold temperature of 40° C. has an amount of tortion of 0.3 or less and the amount of gas of the alcoholic organic solvent released from the bonding layer is within the range of 0.1-100 ppm.

11. The deflection yoke coil which is molded from the self-bonding according to claim 1.
